(19) United States
(12) Patent Application Publication
(10) Pub. No.: US 2023/0070432 A1
(43) Pub. Date: Mar. 9, 2023

(54) ELECTRICAL ENERGY STORAGE DEVICE FOR A MOTOR VEHICLE

(71) Applicant: Valeo Systemes Thermiques, La Verriere (FR)

(72) Inventors: Aurelie BELLENFANT, La Verriere (FR); Bastien JOVET, La Verriere (FR); Lionel ROBILLON, La Verriere (FR)

(73) Assignee: Valeo Systemes Thermiques, La Verriere (FR)

(21) Appl. No.: 17/799,200

(22) PCT Filed: Feb. 11, 2021
(86) PCT No.: PCT/FR2021/050253

§ 371 Date: Aug. 11, 2022

(30) Foreign Application Priority Data
Feb. 12, 2020 (FR) 2001392

(51) Int. Cl. H01M 10/613; H01M 10/6568; H01M 10/625

(52) U.S. Cl. CPC H01M 10/613; H01M 10/6568; H01M 10/625; H01M 2220/20

(57) ABSTRACT

The invention relates to an electrical energy storage device intended for a vehicle, including at least one casing in which there are housed at least two electrical energy storage cells and at least one heat exchanger configured to effect heat exchange between a coolant designed to circulate in the at least one heat exchanger and the electrical energy storage cells. The heat exchanger includes at least one coolant releasing member configured to release the coolant in the casing.

### CROSS-REFERENCE TO RELATED APPLICATIONS

This application is filed under 35 U.S.C. § 371 U.S. National Phase of International Application No. PCT/FR2021/050253 filed Feb. 11, 2021 (published as WO2021160970), which claims priority benefit to French Application No. 2001392 filed on Feb. 12, 2020, the disclosures of which are herein incorporated by reference in their entirety.

### TECHNICAL FIELD

The present invention relates to the field of electric vehicles, and more particularly to the field of the safety associated with the use of these electric vehicles.

### BACKGROUND OF THE INVENTION

In order to respond to present-day climate challenges, there is widespread development of so-called electric or hybrid vehicles, which is to say vehicles which run at least partially on electrical power.

Such vehicles thus comprise an at least partially electric powertrain and are equipped with an electrical energy storage device configured to store electrical energy and release it to the motor in order to cause the latter to turn.

These electrical energy storage devices conventionally comprise a plurality of electrical energy storage cells housed in a protective casing. During the phases in which these electrical energy storage cells are being charged, they have a tendency to heat up. Excessively high temperatures carry the risk of damaging these electrical energy storage cells.

In order to limit the risk of damage to these storage cells as a result of an excessive temperature rise, the casing can comprise, in addition to the storage cells, a cooling device and, for example, a heat exchanger in contact with which the storage cells are arranged and in which there circulates a coolant designed to capture heat energy originating from the storage cells and thus cool them in order to preserve them.

Despite these precautions, incidents can occur and in particular it is possible for one of the storage cells to catch fire, for example as a result of a manufacturing defect with the cell concerned, as a result of a short-circuiting of the storage cells or else as a result of the vehicle being involved in an accident, or as a result of a failure of the cooling device. The outbreak of fire carries the risk of leading to thermal runaway in the electrical storage device, which is to say of the fire spreading from one storage cell to another, and then from the storage device to the vehicle. It is therefore of vital importance to provide systems capable of detecting and extinguishing any outbreak of fire that could occur during use of the vehicle, whether during the running phase or during the phase of charging the cells of the storage device.

### BRIEF SUMMARY OF THE INVENTION

The present invention falls within this context and seeks to address this problem set by proposing a system for releasing a fluid into an electrical energy storage device, the system being designed to detect the outbreak of fire within the casing housing the electrical energy storage cells and to smother this nascent fire.

One subject matter of the present invention thus relates to an electrical energy storage device intended for a vehicle, comprising at least one casing in which there are housed at least one electrical energy storage cell and at least one heat exchanger configured to perform an exchange of heat between a coolant designed to circulate in the at least one heat exchanger and the electrical energy storage cell or cells. According to the invention, the heat exchanger comprises at least one coolant release member configured to release the coolant into the casing.

According to the invention, the coolant circulates through the heat exchanger at a pressure sufficient to allow it to be released sufficiently rapidly in the event of the outbreak of fire. For example, a pressure of 200 bar allows a release that is rapid enough to completely flood the electrical energy storage cells housed in the casing of the electrical energy storage device. Furthermore, a quantity of coolant able to be released by the coolant release member is at least sufficient to flood the electrical energy storage cells. In other words, this quantity of coolant, as well as the pressure at which this coolant circulates through the heat exchanger, are sufficient to at least cover the electrical energy storage cells, thus preventing any risk of fire.

According to the invention, the coolant release member comprises at least one shut-off device configured to at least partially rupture at a temperature greater than 150° C. and/or at a pressure greater than 200 bar.

According to one embodiment of the present invention, the coolant release member comprises at least a head and at least a body, the body comprising at least a first part by means of which it is secured, by screwing, to the heat exchanger, and at least a modular second part attached to the first part and in which the shut-off device is arranged.

The heat exchanger according to the invention is assembled by brazing, which is to say that the elements that make up this heat exchanger are brazed together. Such brazing is performed at very high temperatures, of the order of 600° C. As previously mentioned, the shut-off device of the coolant release member is configured to rupture, at least partially, when the temperature in the casing of the electrical energy storage device increases, following the outbreak of fire. In other words, this shut-off device is configured to rupture, at least partially, at a temperature in the vicinity of 150° C., and therefore needs to be attached to the heat exchanger after the latter has been brazed. According to one example of the present invention, the coolant release member is screwed onto this heat exchanger. For example, a screw thread can be formed on the first part of the body of this release member and a corresponding tapped thread can itself be formed on the heat exchanger. The modular aspect of the second part of the body of the coolant release member advantageously means that only this second part need be replaced, for example after an outbreak of fire has caused the shut-off device borne by this second part to rupture.

For example, the shut-off device can take the form of a membrane designed to tear when a predetermined pressure is applied to it or to melt when raised to a predetermined temperature. For example, one or more nicks forming as many rupture initiators can be formed in this membrane to allow it to rupture when a sufficient pressure is applied to it. Alternatively, the membrane can exhibit different thicknesses, and in particular a central part of the membrane can exhibit a lesser thickness than the rest of the membrane so that this central part ruptures when sufficient pressure and/or temperature is applied to it. Advantageously, this predetermined pressure and predetermined temperature corresponds to the pressure and to the temperature that are reached in the casing of the electrical energy storage device in the event of an outbreak of fire. In other words, the present invention allows a coolant to be released into the casing as soon as an outbreak of fire is detected or else as soon as the conditions for triggering an outbreak of fire are simultaneously present.

According to one feature of the present invention, the heat exchanger comprises at least two header tanks extending in a substantially transverse direction and between which there extend at least two coolant circulation ducts fluidically connected to each header tank, the coolant release member being arranged at one transverse end of at least one of the header tanks. A duct is said to be fluidically connected to a header tank when an opening allows coolant to pass from the header tank to the duct or vice versa. More specifically, the heat exchanger comprises at least an inlet header tank configured to distribute the coolant to the coolant circulation ducts and at least an outlet header tank configured to collect the coolant after it has captured the heat energy originating from the electrical energy storage cells, the coolant release member being able to be positioned, with no preference as to positioning, on the inlet header tank and/or on the outlet header tank.

According to one embodiment of the present invention, the heat exchanger comprises at least one intermediate header arranged between the two header tanks, parallel to these two header tanks, at least one coolant release member being arranged at one end of this intermediate header. First circulation ducts are arranged between one header tank and the intermediate header, and second circulation ducts are arranged between the other header tank and the intermediate header. Advantageously, this at least one intermediate header is arranged at equal distances from the two header tanks.

According to another embodiment of the present invention, the heat exchanger comprises a plurality of intermediate headers arranged between the two header tanks. Advantageously, these intermediate headers are aligned along a straight line parallel to a main straight line of extension of at least one of the header tanks, these intermediate headers being arranged at equal distances from the two header tanks.

According to one feature of the present invention, the at least one coolant release member extends along a main axis of extension parallel to a main direction of extension of the at least one header tank on which this at least one coolant release member is arranged. According to another feature of the present invention, the at least one coolant release member extends along a main axis of extension secant to a main direction of extension of the at least one header tank on which this at least one coolant release member is arranged. Advantageously, the main axis of extension of the coolant release member can be perpendicular to the main direction of extension of the at least one header tank concerned. It must be appreciated that these features are mutually compatible, which is to say that a heat exchanger comprising, on the one hand, at least one coolant release member of which the main axis of extension extends parallel to the main direction of extension of the header tank that bears it and, on the other hand, at least one other coolant release member of which the main axis of extension is secant to the main direction of extension of the header tank that bears it is also covered by the present invention.

According to the invention, the coolant is a fluid composed predominantly of carbon dioxide. In any event, this coolant is selected on the one hand for its ability to capture, transport and release heat energy and, on the other hand, for its ability not to contribute to inflaming and spreading the fire inside the enclosure. In other words, it will be appreciated that the fluid composed predominantly of carbon dioxide acts both as a coolant, when circulating in the heat exchanger, which is to say that it is then configured to capture heat energy originating from the electrical energy storage cells of the electrical energy storage device in order to cool same, and also as an extinguishant, which is to say a fluid capable of smothering a nascent fire, notably by being sprayed into the casing at a high flow rate to almost instantaneously fill the volume defined by the casing and expel the oxygen present that would encourage the fire to spread.

The present invention also relates to a motor vehicle comprising at least one electrical energy storage device as described hereinabove.

### BRIEF DESCRIPTION OF THE DRAWINGS

Further features, details and advantages of the invention will become more clearly apparent from reading the following description, and also from a number of exemplary embodiments given by way of non-limiting indication, with reference to the appended schematic drawings, in which:

FIG. 1 is a schematic illustration, viewed in transverse section, of an electrical energy storage device according to the present invention;

FIG. 2 is a schematic perspective illustration of a coolant release member intended to be incorporated into an electrical energy storage device according to the invention;

FIG. 3 is a schematic illustration, viewed in longitudinal section, of the coolant release member illustrated in FIG. 2, this coolant release member being depicted as incorporated into a header tank of a heat exchanger of the electrical energy storage device according to a first embodiment of the invention;

FIG. 4 is a schematic illustration, viewed from above, of the electrical energy storage device according to the first embodiment, a casing of this electrical energy storage device being depicted in longitudinal section in order to render the elements housed inside this casing visible;

FIG. 5 is a schematic illustration, viewed from above, of the electrical energy storage device according to a second embodiment, a casing of this electrical energy storage device being depicted in longitudinal section in order to render the elements housed inside this casing visible;

FIG. 6 is a schematic illustration, viewed from above, of the electrical energy storage device according to a third embodiment, a casing of this electrical energy storage device being depicted in longitudinal section in order to render the elements housed inside this casing visible; and

FIG. 7 is a schematic illustration, viewed from above, of the electrical energy storage device according to a variant of the first embodiment of the present invention, a casing of this electrical energy storage device being depicted in longitudinal section in order to render the elements housed inside this casing visible.

### DETAILED DESCRIPTION OF THE INVENTION

The features, variants and different embodiments of the invention can be combined with each other, in various combinations, provided that they are not incompatible or mutually exclusive. In particular, variants of the invention can be envisaged that comprise only a selection of the features described below in isolation from the other features described, if this selection of features is sufficient to provide a technical advantage or to distinguish the invention from the prior art.

In the figures, the terms longitudinal, vertical, transverse, left, right, above, below refer to the orientation of the L, V, T trihedron. Within this frame of reference, a longitudinal axis L represents a longitudinal direction, a transverse axis T represents a transverse direction, and a vertical axis V represents a vertical direction of the object concerned. In the description that follows, the terms “electrical energy storage” and “storage” will be used indiscriminately, a transverse section will correspond to a section taken in a transverse and vertical plane, which is to say a plane containing the transverse axis T and the vertical axis V of the trihedron, and a “longitudinal” section will correspond to a section taken in a longitudinal and transverse plane, which is to say a plane containing the longitudinal axis L and transverse axis T of the trihedron illustrated.

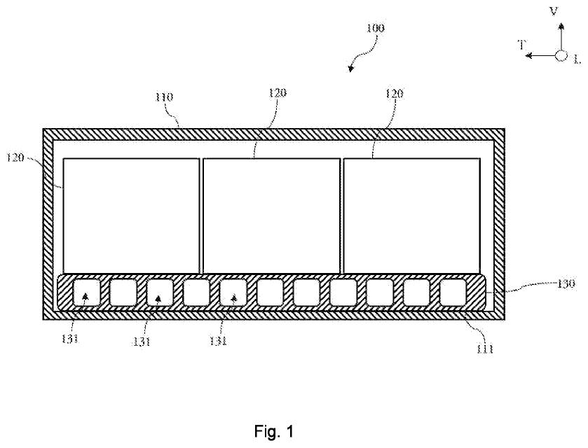

FIG. 1 thus illustrates, viewed in transverse section, an electrical energy storage device 100 according to the invention. As depicted, this electrical energy storage device 100 comprises at least a casing 110 which houses at least one, and advantageously a plurality of, electrical energy storage cells 120 and at least one heat exchanger 130 dedicated to the thermal management of the electrical energy storage cells 120. Optionally, the electrical energy storage device 100 according to the invention can comprise a plurality of heat exchangers 130, each one dedicated to the thermal management of one or of a plurality of electrical energy storage cells 120.

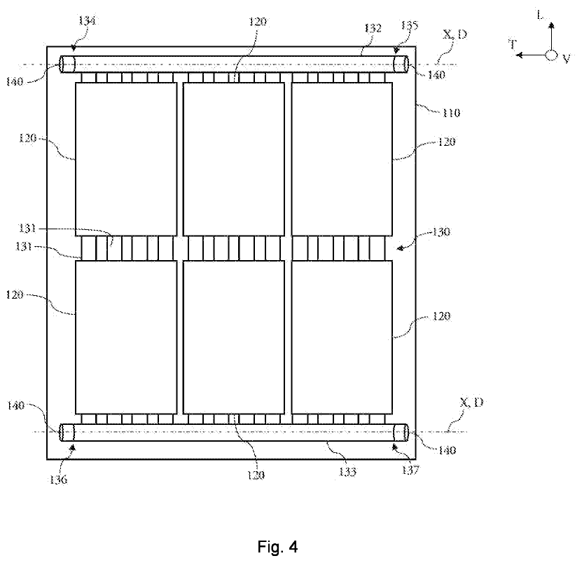

The heat exchanger 130 comprises at least two header tanks 132, 133—for example illustrated in FIGS. 4 to 7—between which there extends at least one duct 131 in which a coolant is able to circulate. According to the example illustrated, the heat exchanger 130 comprises a plurality of ducts 131. Each of these ducts 131 opens onto one of the header tanks 132, 133 and there is fluidic communication between the ducts 131 and the header tanks 132, 133 so that the coolant can circulate through the entirety of the heat exchanger 130. More specifically, the heat exchanger 130 comprises an inlet header tank configured to distribute the coolant to the ducts 131 and an outlet header tank configured to collect the coolant once the exchange of heat with the electrical energy storage cells 120 has taken place.

The electrical energy storage cells 120 are arranged in contact with the heat exchanger 130 or at the very least in the direct vicinity of, and more particularly in contact with, the ducts 131 in which the coolant circulates. Where appropriate, a thermal compound can be interposed between the electrical energy storage cells 120 and the ducts 131. During the course of use, the electrical energy storage cells 120 have a tendency to heat up, and this phenomenon is aggravated during the so-called “charging” phases, which is to say when the electrical energy storage cells 120 are in the process of accumulating the electrical energy that they are intended to store. Such temperature increases are undesirable because they can lead to irreversible damage to these electrical energy storage cells 120. Thus, when these electrical energy storage cells 120 heat up, the coolant that circulates in these ducts 131 is configured to capture heat energy originating from these electrical energy storage cells 120 in order to cool them.

The heat exchanger 130 is moreover placed in a coolant circuit—not illustrated here—by means of which the coolant, in a zone distant from the electrical energy storage cells 120, rids itself of the heat energy thus captured so that it is once again able to capture heat energy originating from the electrical energy storage cells 120 once it returns to the ducts 131 of the heat exchanger 130. The coolant circuit can, without departing from the context of the invention, be fully contained in the casing 110, or equally can extend partially outside the casing 110 so that the zone distant from the electrical energy storage cells 120 is outside the casing 110.

According to the invention, this coolant is a non-flammable fluid able to exchange heat energy with the electrical energy storage cells 120. For example, this coolant is composed predominantly of carbon dioxide.

The heat exchanger 130 is thus arranged, on the one hand, in contact with the electrical energy storage cells 120 and, on the other hand, in direct or indirect contact with a bottom wall 111 of the casing 110. In other words, this heat exchanger 130 can be arranged directly in contact with this bottom wall 111 or, alternatively, a support element can be interposed between the bottom wall 111 of the casing 110 and the heat exchanger 130. Optionally, this support element can be configured to apply a vertical pressure, which is to say a pressure that is applied parallel to the vertical axis V of the trihedron illustrated, on the bottom wall 111 so as to press the heat exchanger 130 intimately against the electrical energy storage cells 120 so as to optimize the exchange of heat that takes place between the coolant circulating in the heat exchanger 130 and these electrical energy storage cells 120.

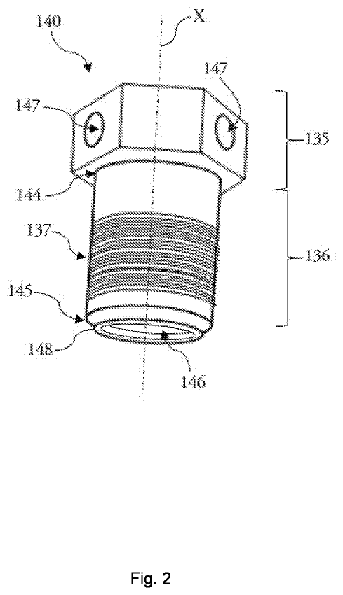

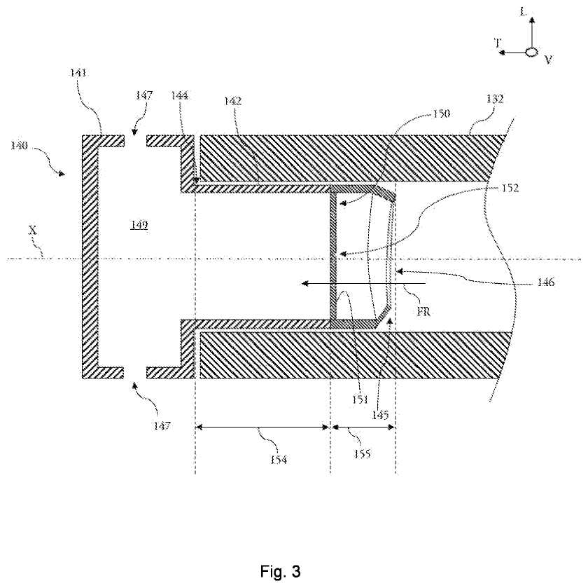

According to the invention, at least one of the header tanks 132, 133 of the heat exchanger 130 comprises a coolant release member 140 for example illustrated in FIGS. 2 and 3. What is meant by a “coolant release member 140” is a member configured to allow the coolant that circulates in the heat exchanger 130 to escape from this heat exchanger 130 under certain predetermined conditions. According to the invention, the coolant release member 140 is more particularly configured to allow the coolant to be released into the casing 110 of the electrical energy storage device 100 when a temperature or pressure within this casing 110 exceeds a predetermined threshold value. Advantageously, this threshold value is determined such that the release of fluid takes place in the event of an outbreak of fire within one of the electrical energy storage cells 120 housed in said casing 110. It will be appreciated that this release of fluid allows the electrical energy storage cells 120 to be flooded so that the fire is rapidly put out, thus limiting the potential damage it could cause were it to spread. In other words, a quantity of coolant circulating in the heat exchanger 130 and able to be released into the casing 110 by the at least one coolant release member 140 is at least sufficient to cover the electrical energy storage cells 120. It must also be appreciated that the pressure of the coolant in the heat exchanger 130 is chosen to allow this release of coolant throughout the casing 110. For example, the coolant thus circulates at a pressure comprised between 25 and 132 bar.

FIGS. 2 and 3 thus illustrate one embodiment of such a coolant release member 140, FIG. 2 being a perspective view of this coolant release member 140 and FIG. 3 being a cross-sectional view of this coolant release member 140 incorporated into a header tank 132 of the heat exchanger 130. It must be appreciated that this is merely one embodiment and that any other coolant release member 140 offering the same functionalities as those described hereinbelow can be contemplated without departing from the scope of the present invention.

According to the example illustrated, the coolant release member 140 takes the overall form of the screw, which is to say extends predominantly along the main axis of extension X and comprises at least a head 141 and a body 142 which are aligned one after the other along the main axis of extension X. A screw thread 143 is formed on the body 142 so that it can be mounted, in this instance by screwing, on at least one of the header tanks 131, 132 of the heat exchanger 130, said header tank 132 being equipped with a corresponding tapped thread. It must be appreciated that any other means for mounting of this coolant release member 140 on the heat exchanger 130 can be contemplated without departing from the scope of the present invention. The body 142 has a cylindrical or substantially cylindrical shape, open at both ends. A first end 144 of the body 142 is thus in communication with a hollow body 149 limited by the head 141 of the coolant release member 140 and a second end 145 of this body 142 itself opens onto an environment external to this coolant release member 140, via an orifice 146.

According to the invention, this coolant release member 140 is intended to be mounted on the heat exchanger 130 via the second end 145 of the body 142. In other words, the coolant FR that circulates through the heat exchanger 130 is able to reach the body 142 of the coolant release member 140 via the orifice 146 formed in this second end 145 of the body 142, and then reach the head 141 of the coolant release member 140, and more particularly the hollow body 149 delimited by this head 141, via the first end 144 of the body 142. At least one hole 147, advantageously a plurality of holes 147, is formed in the head 141 of the coolant release member 140, this (these) hole(s) being configured to allow the coolant to be released out of the heat exchanger 130, which is to say, when the coolant release member 140 is mounted on the corresponding header tank 132, into the casing 110 of the electrical energy storage device 100.

It will therefore be appreciated that the coolant is able, under certain conditions, and notably under the condition of there being a fluidic communication between the header tank 131, 132 and the internal volume of the body 142 of the coolant release member 140, to leave the heat exchanger 130 header tank 131, 132 through which it is circulating and reach, first of all, the body 142 of the coolant release member 140, then the hollow body 149 delimited by the head 141 of this coolant release member 140, and finally the enclosure inside the casing 110 of the electrical energy storage device 100. Once again, it must be appreciated that, under conditions of use at normal temperatures and pressures, the shut-off device 150 prevents the coolant from reaching the hollow body 149 delimited by the head 141 of the coolant release member 140, this coolant therefore circulating exclusively through the heat exchanger 130 and through the coolant circuit that bears this heat exchanger 130.

In order to avoid any leak of coolant, a sealing device 148—for example illustrated in FIG. 2—is optionally interposed between the heat exchanger 130, and more particularly between one of the header tanks 132, 133 of this heat exchanger 130, and the second end 145 of the body 142 of the coolant release member 140. In other words, this sealing device 148 extends around a periphery of the orifice 146 formed in the second end 145 of the body 142.

As previously mentioned, the coolant release member 140 is more particularly configured to allow the coolant to be released when the pressure and/or the temperature within the casing 110 exceeds a predetermined threshold value. As illustrated in FIG. 3, the coolant release member 140 comprises a shut-off device 150 arranged in the body 142 of the coolant release member 140 downstream of the orifice 146 with respect to a direction in which the coolant FR circulates in this coolant release member 140, this shut-off device 150 being configured to allow the coolant FR to pass only when the temperature and/or the pressure in the casing 110 exceeds the threshold value.

According to the example illustrated, this shut-off device 150 takes the form of a membrane 151 which has at least one nick 152 that forms a rupture initiator. In other words, this membrane 151 is thus weakened at this at least one nick 152 so that when sufficient pressure is applied to this membrane 150 it tears, thus releasing the coolant FR into the casing 110 of the electrical energy storage device 100.

Alternatively, provision can be made for the membrane to have a thickness that is calculated such that it tears when sufficient pressure is applied to it. According to yet another alternative, this membrane can be made from a material which melts upwards of a certain temperature, advantageously the predetermined threshold value.

The body 142 of this coolant release member 140 more particularly comprises at least a first part 154 on which the screw thread 143 is formed and at least a second part 155 bearing the shut-off device 150. Thus, as illustrated, the first part 154 of the body 142 extends from the head 141 of the coolant release member 140 as far as the shut-off device 150, and the second part 155 of the body 142 itself extends from the shut-off device 150, which forms part of this second part 155 of the body 142, as far as the orifice 146 that contributes to forming the second end 145 of this body 142. Advantageously, an embodiment such as this made up of two distinct parts makes the shut-off device 150 easier to replace after it has been torn. It will effectively be appreciated that, if the shut-off device 150 ruptures, the coolant release member 140 can be unscrewed from the header tank 132 that bears it so that the second part 155 of the body 142 can be removed and replaced with another, new, second part 155, which is to say a second part 155 comprising an intact shut-off device 150.

It follows from the foregoing that the shut-off device 150 is, according to the example illustrated here, arranged near the second end 145 of the body 142 of the coolant release member 140, namely closer to this second end 145 of the body 142 than to the head 141 of this coolant release member 140.

FIGS. 4 to 7 illustrate various embodiments and embodiment variants of the electrical energy storage device 100 according to the invention, which differ from one another notably in terms of the position and orientation of the coolant release member 140 with respect to the heat exchanger 130. These figures more particularly illustrate the electrical energy storage device 100, viewed from above, and in which the casing 110 is depicted viewed in longitudinal section so as to render visible the heat exchanger 130 and the electrical energy storage cells 120 of this electrical energy storage device 100. According to the examples illustrated here, the electrical energy storage device 100 comprises six electrical energy storage cells 120 distributed over two rows. In other words, these electrical energy storage cells 120 are aligned, in threes, along two parallel transverse axes. It must be appreciated that this is merely one exemplary embodiment and that provision could be made for the electrical energy storage device 100 to comprise a lower or higher number of electrical energy storage cells 120 without departing from the context of the present invention.

As previously mentioned, the heat exchanger 130 comprises an inlet header tank 132, an outlet header tank 133 and a plurality of ducts 131 in which the coolant circulates and which extend between the inlet header tank 132 and the outlet header tank 133. As illustrated, the inlet header tank 132 and the outlet header tank 133 extend respectively along a main straight line of extension D parallel to the transverse axis T of the trihedron illustrated. For example, the heat exchanger 130 can comprise at least one coolant release member 140 arranged at one transverse end of one of the header tanks 132, 133. Advantageously, the heat exchanger 130 comprises a plurality of coolant release members 140 distributed at each of the transverse ends 134, 135, 136, 137 of these header tanks 132, 133.

If a fire breaks out at one of the electrical energy storage cells 120, a pressure and/or temperature in the casing 110 increases sharply. As previously mentioned, such an increase in the pressure and/or the temperature within the casing 110 causes the rupturing of the shut-off device arranged in the coolant release member 140 closest to the outbreak of the fire, namely in the coolant release member 140 that is experiencing the greatest change in temperature/pressure. This results in the filling of the casing 110, in a zone around this coolant release member 140, and therefore around the electrical energy storage cell 120 in which the fire is starting. According to the invention, the release of coolant continues until the casing 110 is completely, or almost completely, filled with coolant. Advantageously, the invention thus allows the coolant composed predominantly of carbon dioxide to be released quickly and as close as possible to the outbreak of the fire, thus ensuring that the nascent fire is rapidly put out, which is to say that the supply of oxygen to this nascent fire is thus cut off rapidly, thereby preventing the fire from spreading.

According to a first embodiment illustrated in FIG. 4, the heat exchanger 130 comprises four coolant release members 140. Thus, according to this first embodiment, a first coolant release member 140 is arranged at a first inlet transverse end 134 of the inlet header tank 132, a second coolant release member 140 is arranged at a second inlet transverse end 135 of the inlet header tank 132, a third coolant release member 140 is arranged at a first outlet transverse end 136 of the outlet header tank 133 and a fourth coolant release member 140 is arranged at a second outlet transverse end 137 of the outlet header tank 133. According to the example illustrated here, the main axis of extension X of each coolant release member 140 is coincident with the main straight line of extension D of the header tank 132, 133 that bears the coolant release member 140 concerned.

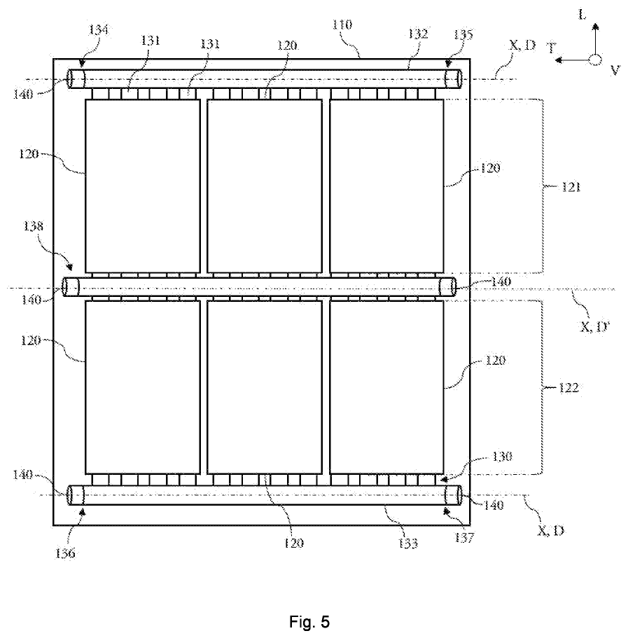

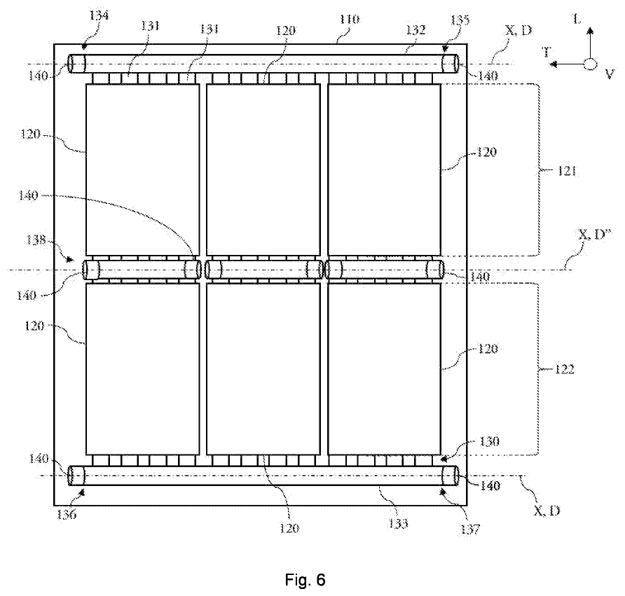

The second and third embodiments illustrated in FIGS. 5 and 6 respectively differ from the first embodiment in that the heat exchanger 130 comprises at least one intermediate header 138 arranged substantially at equal distances from the inlet header tank 132 and from the outlet header tank 133. As depicted, this at least one intermediate header 138 is positioned between a first row 121 of three electrical energy storage cells 120 and a second row 122 of three electrical energy storage cells 120. In other words, this at least one intermediate header 138 is positioned substantially at a center of the electrical energy storage device 100. Advantageously, this at least one intermediate header 138 is equipped with at least one, advantageously at least two, coolant release members 140.

According to the second embodiment illustrated in FIG. 5, the heat exchanger 130 comprises a single intermediate header 138 equipped with two coolant release members 140 arranged respectively at each of the transverse ends of this intermediate header 138. According to the example illustrated, it will be noted that this intermediate header 138 is identical, or almost identical, to the header tanks 132, 133 which are themselves distributed at the longitudinal ends of the heat exchanger 130, the only difference being that ducts 131 are fluidically connected to the intermediate header 138 on each side thereof. In other words, this intermediate header 138 extends mainly along a main straight line of extension D′ parallel to the transverse axis T of the trihedron illustrated and has a shape and dimensions that are equivalent or almost equivalent to the shape and dimension of the header tanks 132, 133. It must be appreciated that this is merely one embodiment and that this intermediate header 138 could be different without departing from the scope of the present invention, provided that it comprises at least one coolant release member 140 exhibiting the features described hereinabove.

According to the third embodiment illustrated in FIG. 6, the heat exchanger 130 comprises three intermediate headers 138 aligned along a transverse straight line D″, which is to say a straight line parallel to the transverse axis T, and each of the intermediate headers is equipped with two coolant release members 140 distributed at the two transverse ends of each of these intermediate headers 138. Once again, this is merely one embodiment and provision can be made for a different number of coolant release members 140 to be distributed along each intermediate header 138, and the heat exchanger 130 to comprise a different number of intermediate headers 138, without departing from the scope of the present invention.

It can be noted that, according to the embodiments illustrated in FIGS. 5 and 6, the main axis of extension X of each coolant release member 140 is coincident with the main straight line of extension D′ of the intermediate header 138 or with the transverse direction D″ along which the intermediate headers 138 bearing these coolant release members 140 are aligned.

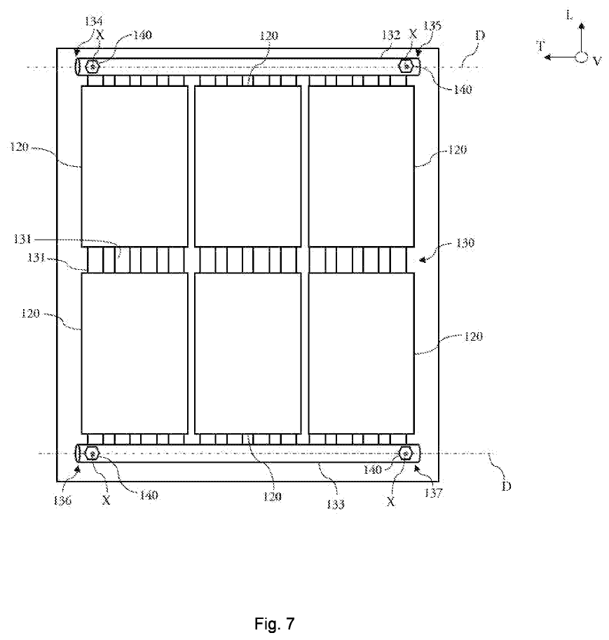

FIG. 7 illustrates a variant of the first embodiment. This variant differs from the first embodiment illustrated in FIG. 4, in terms of the orientation of the coolant release members 140. Thus, in the three embodiments that have just been described, the coolant release members 140 are arranged at the transverse ends of the header tanks 132, 133/intermediate headers 138 and predominantly extend parallel to the transverse axis T. In other words, the coolant release members 140 are arranged in such a way that the coolant has to pass through these coolant release members 140 in a transverse direction substantially in the continuation of the corresponding header tank 132, 133. In the variant illustrated in FIG. 7, it can be appreciated that these coolant release members 140 are also arranged near the transverse ends of the header tanks 132, 133, which is to say closer to the transverse ends of these header tanks 132, 133 than to a center thereof, but that the orientation of these coolant release members 140 differ in that they extend parallel to the vertical axis V. In other words, the main axis of extension X of each coolant release member 140 is secant, advantageously perpendicular, to the main direction of extension D of the header tanks 132, 133. The principle of operation of the coolant release members 140 according to this variant is identical to that described hereinabove.

Advantageously, this embodiment variant can also be transcribed to the second and third embodiments illustrated in FIGS. 5 and 6, which is to say that, according to the invention, the main axis of extension X of each coolant release member 140 is transverse, advantageously perpendicular, to the main straight line of extension of the single intermediate header 132, 133 or to the transverse direction in which the intermediate headers 138 are aligned.

According to another variant of the first embodiment, which is not illustrated here, the coolant release members 140 are arranged some distance from the transverse ends, for example closer to a center of the header tank 132, 133 that bears them than to any one of these transverse ends. The rest of the description that has just been given with reference to FIG. 7 applies mutatis mutandis to this other unillustrated variant.

It will be appreciated from reading the foregoing that the present invention proposes a simple and inexpensive means able to manage outbreaks of fire that can arise at the electrical energy storage devices 100 in electric or hybrid vehicles equipped with such devices, and more particularly that makes it possible to smother such a nascent fire, thus improving the safety of the users of the vehicle concerned and also the safety of other road users that share the road with these vehicles.

The invention is not, however, limited to the means and configurations described and illustrated here, but also extends to any equivalent means or configuration and to any technically operational combination of such means. In particular, the number, shape and arrangement of coolant release members 140 can be modified without detriment to the invention, provided that they provide the functionalities described in the present document.

What is claimed is:

1. An electrical energy storage device intended for a vehicle, comprising at least one casing in which there are housed at least one electrical energy storage cell and at least one heat exchanger configured to perform an exchange of heat between a coolant designed to circulate in the at least one heat exchanger and the at least one electrical energy storage cell, wherein the heat exchanger includes at least one coolant release member configured to release the coolant into the at least one casing.

2. The electrical energy storage device as claimed in claim 1, wherein the at least one coolant release member includes at least one shut-off device configured to at least partially rupture at a temperature greater than 150° C. and at a pressure greater than 200 bar.

3. The electrical energy storage device as claimed in claim 2, wherein the at least one coolant release member includes a head and a body, the body including a first part by means of which it is secured, by screwing, to the at least one heat exchanger, and a modular second part attached to the first part and in which the shut-off device is arranged.

4. The electrical energy storage device as claimed in claim 1, wherein the at least one heat exchanger includes at least two header tanks extending in a transverse direction and between which there extend at least two coolant circulation ducts fluidically connected to each of the at least two header tanks, the at least one coolant release member being arranged at one transverse end of at least one of the header tanks.

5. The electrical energy storage device as claimed in claim 4, wherein the at least one heat exchanger includes at least one intermediate header arranged between the at least two header tanks, parallel to these at least two header tanks, the at least one coolant release member being arranged at one end of the at least one intermediate header.

6. The electrical energy storage device as claimed in claim 5, wherein the at least one heat exchanger includes a plurality of intermediate headers arranged between the two header tanks.

7. The electrical energy storage device as claimed in claim 4, wherein the at least one coolant release member extends along a main axis of extension parallel to a main direction of extension of the at least one header tank on which the at least one coolant release member is arranged.

8. The electrical energy storage device as claimed in claim 4, wherein the at least one coolant release member extends along a main axis of extension secant to a main direction of extension of the at least one header tank on which this at least one coolant release member is arranged.

9. The electrical energy storage device as claimed in claim 1, wherein the coolant is a fluid composed predominantly of carbon dioxide.

10. A motor vehicle comprising at least one electrical energy storage device including at least one casing in which there are housed at least one electrical energy storage cell and at least one heat exchanger configured to perform an exchange of heat between a coolant designed to circulate in the at least one heat exchanger and the at least one electrical energy storage cell, wherein the heat exchanger includes at least one coolant release member configured to release the coolant into the at least one casing.

11. The electrical energy storage device as claimed in claim 1, wherein the at least one coolant release member includes at least one shut-off device configured to at least partially rupture at a temperature greater than 150° C. or at a pressure greater than 200 bar.
